(19) United States
(12) Patent Application Publication
(10) Pub. No.: US 2009/0132592 A1
(43) Pub. Date: May 21, 2009

(54) Methods of pre-production and casting

(76) Inventor: Christopher James Schiller, Studio City, CA (US)

Correspondence Address: Christopher James Schiller, 4045 Vineland Avenue, Apt. 417, Studio City, CA, 91604, US

(21) Appl. No.: 11/986,405

(22) Filed: Nov. 20, 2007

(51) Int. Cl. G06F 17/30

(52) U.S. Cl. 707/104.1; 707/E17.009

(57) ABSTRACT

This invention relates to methods of pre-production and casting in the early stages of a program, preferably a reality television, internet, or other media-based program, including a program cast selecting method whereby a database of potential participants is created and accessible to users via a social network on the internet, and the users vote for or against the participants they want or do not want on the program. The feasibility of the production can be assessed based upon the cast selecting method and other factors so that the pre-production phase is economically executed.

### TECHNICAL FIELD

This invention relates to a method of production in the early stages of a program, also called pre-production, including a program cast selecting method and a method of forecasting the feasibility of the program.

### BACKGROUND ART

Producing a program can be very expensive, time consuming, and arduous. For example, pre-production costs are hefty for most studio budgets, with costs including payroll for the production team, at least one or more casting coordinators, one or more casting teams, a director, and one or more producers. Much time is spent casting, on location scouts, and planning for shooting. Casting may involve holding auditions in several cities. This requires one or more casting teams to travel to these cities, rent a location to hold the auditions, and hire security and other staff to help with the event. Scouting appropriate locations for the program may require trips to locations via air travel and include costs for lodging, food, and car and equipment rentals. Additionally, constructing sets may require materials, expensive items such as furniture, and experts in construction such as contractors, carpenters, and electricians.

All of these items and the costs involved amount to large fees incurred, prior to the beginning of the production, and prior to any sense as to how successful the program will be. This may add up to be a large amount of money, before the show has even started, and if the show is unsuccessful, the time and money are wasted. The studio, production company, or other entity producing the program is left with the debts of the pre-production exercise, and behind in the never ending race to air the next new, popular show.

Location scouting, set preparation, and auditions usually run over the course of several days, and auditions in remote locations may create traffic and parking problems, and congestion at casting site locations. Often, the auditions create unsafe environments for all when potential candidates, often in the thousands, camp out overnight on streets, sidewalks, and parking lots.

In light of this, creating a new show is a significant risk for a studio production company, or other entity producing the program if the show is ultimately a flop. There is no way to gauge how successful a show will be in the pre-production phases. Accordingly, there is a need in the art to reduce production costs and add convenience to the tasks of a production team, all the while providing the studio, production company, or other entity producing the program with a way to lower the risk involved in creating a new show. There is also a need to be able to quantify the relative success of a show with reasonable certainty, and ideally the method of predicting the success of a program will be able to generate revenue for the show in its pre-production stage. For these reasons, there is a need in the art to streamline methods of casting, to be able to reasonably forecast the success of a show, and to be able to develop a show in a financially responsible way, all in the pre-production stage.

### DISCLOSURE OF INVENTION

The present invention comprises a method and a system for casting a program and a method for pre-production, a system for predicting whether or not to produce the program, and a method of forecasting whether to produce the program, where the methods and systems help to identify candidates for the cast, and assess the viability of a new show in a cost-effective and efficient manner.

In one embodiment of the invention, the inventive method comprises a method of casting a program comprising providing at least one server computer in communication with a computer network, generating output from the server to a website announcing a reality television, internet, or other media-based program and a casting competition, including guidelines for the competition wherein votes may be positive votes for or negative votes against a potential candidate; receiving baseline popularity measurements input to the server from a production team, including a target number of preferred potential cast members; receiving input to the server via the website from potential candidates for the program, wherein the potential candidate input is video, photo, text, and music; receiving input to the server via the website from voter candidates, wherein the voter candidate input is one or more positive or negative votes for one or more potential candidates; processing a total number of positive votes and a total number of negative votes per potential candidate, and processing a rating for each potential candidate by subtracting the total number of negative votes from the total number of positive votes per potential candidate; generating output from the server that identifies the rating for each potential candidate in consecutive order and selects the target number of potential candidates having the highest ratings. In connection with the inventive method, the target number of eligible potential candidates having the highest ratings may be invited by the casting team to a casting audition, or the target number of eligible potential candidates having the highest ratings may be invited to appear on the program. Additionally, the guidelines for the casting competition may provide that the potential candidates with the highest rating may be selected for the cast. In view of the receipt of negative and positive votes, and the potential candidate rating received based upon the positive votes minus negative votes, it is possible that a potential candidate having the highest total number of positive votes for may lose if they have a large total number of negative votes against.

The inventive method may further comprise generating output from the server as a message service for potential candidates to request votes from voter candidates; receiving input to the server from potential candidates regarding addresses to send one or more messages; and generating output from the server appearing as one or more messages to the addresses identified from the potential candidate. The message service will assist potential candidates in requesting, or campaigning for votes. It will also serve to advertise the show as potential candidates will be spreading information about the show and their desire to be a cast member. The messages are selected from the group consisting of email, text, voice, and combinations thereof.

In one embodiment, the potential candidate text input may be one or more categories of potential candidate directory information wherein categories of directory information are age, sex, geographic location, and other categorical identifiers; and combinations thereof. This information can provide the entity producing the show with an idea of who is interested in the show and where they are located.

Another embodiment of the invention includes a system for casting a reality television, internet, or other media-based program, in a computer network, the system comprising: at least one server computer hosting a website displaying program guidelines and a casting competition, said server having an interface for communicating over a computer network with one or more potential candidates, one or more voter candidates, and a production team; a baseline popularity measurements database storing baseline popularity measurements input from the production team, such measurements including the target number of potential candidates; a potential candidate database associated with the server for receiving information from potential candidates input from the website displaying the program guidelines and the casting competition; a voter candidate database associated with the server for receiving information from voter candidates input from the website; a database engine associated with the server which calculates the number of positive votes for minus the negative votes against each potential candidate to generate a rating for each potential candidate; whereby the target number of potential candidates with the highest rating are selected as potential cast members of the reality television program.

Yet another embodiment of the invention is a method for pre-production of a reality television, internet, or other media-based program comprising: providing at least one server computer in communication with a computer network; generating output from the server to a web site announcing the reality program; receiving input to the server of a plurality of baseline popularity measurements from a production team; receiving input to the server from one or more potential candidates for the program, wherein the potential candidate input is video, photo, text, music, and categories of potential candidate directory information wherein categories of directory information are age, sex, geographic location, occupation, marital status, and other categorical identifiers, and combinations thereof; receiving input to the server from voter candidates, wherein the voter candidate input is one or more positive votes for or negative votes against one or more potential candidates, and categories of voter candidate directory information; receiving input to the server of advertising revenue generated by the visits to the web site; processing the number of positive and negative votes per potential candidate, processing a voter rating for each candidate based upon the number of positive votes minus negative votes, the total number of potential candidates, the total number of voter candidates, the total number of visits to the web site, and total amount of advertising revenue; processing the categories of potential candidate directory information and the categories of voter candidate directory information to quantify the number of potential candidates and voter candidates in each category; generating output from the server that identifies the voter rating of each potential candidate, the total number of potential candidates, the total number of voter candidates, and the total number of visits to the web site, the total number of potential candidates and voters in each directory information category, a list of potential cast members, and a popularity analysis; wherein the preferred number of potential cast members included in the baseline popularity measurements input by the production team are identified from the potential candidates having the highest voter rating, and the popularity analysis is based upon a comparison of one or more baseline popularity measurements with the total number of potential candidates, the total number of voter candidates, the total number of visits to the web site, the total advertising revenue received, and the total number of potential and voter candidates in each category of directory information; and generating output from the server that provides a recommendation for whether or nor to produce the reality program based upon the popularity analysis.

A recommendation for whether or not to produce the show may be provided in any format; for example, the recommendation may be highly recommend, slightly recommend, do not recommend; or may be in numerical form; or in text form as “yes” or “no” or other text tending to provide a favorable or negative recommendation.

The recommendation may be highly recommend or other favorable indication to move forward with the show if the results of the popularity analysis show that more than 75% of the baseline popularity measurements are met. The recommendation is slightly recommend or other neutral indication if the results of the popularity analysis show that 50% or more of the baseline popularity measurements are met. The recommendation may show some indicator of a favorable recommendation if 50% or more of the baseline popularity measurements are met, and a sliding scale of recommendations may be implemented the higher the percentage of baseline popularity measurements are met. The baseline popularity measurements may also be weighted such that one of the factors holds more weight over another; for example, if the amount of advertising revenue received weighs more heavily than geographic location of the potential candidates and voter candidates, the amount of advertising revenue will weigh more heavily in the recommendation analysis. The recommendation is do not recommend or other nonfavorable indication if the results of the popularity analysis show that less than 50% of the baseline popularity measurements are met.

The method may also include a mail service for potential candidates to request votes whereby the method involves generating output from the server requesting one or more addresses and a message, receiving input to the server of one or more addresses from the potential candidates and the message, and generating output from the server of mail containing the message to each of the one or more addresses. This will also assist in advertising the program.

In another embodiment of the invention, a system for predicting, in a computer network, whether or not to produce a reality television program is contemplated. Specifically, the inventive system is a system for predicting, in a computer network, whether or not to produce a reality television, internet, or other media-based program in the pre-production stage of the program, the system comprising: at least one server computer hosting a website displaying program guidelines and a casting competition, said server having an interface for communicating over a computer network with one or more potential candidates, one or more voter candidates, and a production team; a database storing a plurality of baseline popularity measurements associated with the server for receiving information from the production team; a potential candidate database associated with the server for receiving information from potential candidates input from the web site displaying the reality television program guidelines and the casting competition; a voter candidate database associated with the server for receiving information from voter candidates input from the web site displaying the program guidelines and the casting competition; a database engine associated with the server that compares the baseline popularity measurements with the total number of potential candidates, the number of voter candidates, the voter rating per potential candidate, and the number of hits to the web site; whereby the reality television program is highly recommended, slightly recommended, or not recommended based upon the comparison of the database engine. The information from the voter candidates may include both positive votes for one or more potential candidates and negative votes against one or more potential candidates. In the calculation of the number of votes granted per potential candidate, the system will take into account the number of negative votes against the potential candidate by subtracting the number of negative votes from the number of positive votes to arrive at the voter rating. If the voter candidates only provide positive votes, the voter rating of a potential candidate will not include any offsets for negative votes.

The recommendations of the system may be alternatively based upon other text or numerical value tending to show whether the program will be successful or not. Additionally, the measurements for whether or not the program is recommended may be weighted such that certain factors compared with the baseline popularity measurements are given greater weight than other factors.

The program may be successful and highly recommended for production if 75% of the baseline popularity measurements are met. If a favorable recommendation results from the system, then the entity producing the show will have a reasonable basis upon which to move forward with the production, thereby minimizing the risk involved with producing the program. This will save large amounts of time and money and allay any fears or concerns regarding production of the program. Additionally, it is likely that the program will already be earning revenue for the entity producing the show due to the automatic advertising from the web site and the potential candidates and voter candidates.

In one embodiment of the system, the preferred number of potential cast members may be selected from the potential candidates with the highest voter rating. For example, the potential candidates with the highest voter rating may be selected to attend an audition or be subject to further screening. The casting team may then exercise their creative control over who will appear on the program by selecting the cast from the group of potential candidates. Alternatively, the show may be cast based upon the potential candidates with the highest voter ratings, without the need to further screen or otherwise participate in an audition.

The system may further comprise an advertising revenue database for storing information related to the value of advertising revenue received from the website, and the baseline popularity measurements may further comprise a preferred value of advertising revenue. If such a value is included, baseline values of revenue can serve as an additional factor as to whether the program will ultimately be successful and thus should move to full production.

The inventive system may predict the popularity of the reality television program by providing a recommendation rating for actual production of the program. In one embodiment of the system, the recommendation rating is based upon the number of baseline popularity measurements met. The recommendation rating may be highly recommend if the results of the popularity analysis show that more than 75% of the baseline popularity measurements are met.

The invention may further comprise a method that forecasts whether or not to produce a reality television, internet, or other media-based program in the early pre-production stage, the method comprising: providing a web site that includes information on the reality television program and guidelines for participating in a casting competition, and a mechanism for potential candidates to provide information, voter candidates to vote for potential candidates, and a production team to input baseline popularity measurements; providing baseline popularity measurements, wherein the baseline popularity measurements quantify the preferred number of potential cast members for the reality television program, the preferred number of voter candidates, the preferred number of hits to the web site, and the preferred amount of advertising revenue generated from the web site; receiving video, photo, text, music, and combinations thereof, from potential candidates for the program; receiving votes from voter candidates that are positive votes for or negative votes against one or more potential candidates; receiving advertising revenue generated by visits to the web site; processing the voter rating per potential candidate equal to the positive votes minus negative votes received, the total number of potential candidates, the total number of voter candidates, the total number of visits to the web site, and total amount of advertising revenue; identifying potential cast members by selecting the preferred number of potential cast members from the potential candidates with the highest voter rating; providing a recommendation of whether or not to produce the reality television program by comparing the baseline popularity measurements with the total number of potential candidates, the total number of voter candidates, the total number of visits to the web site, and total amount of advertising revenue; wherein producing the reality program is highly recommended if 75% of the baseline popularity measurements are met, slightly recommended if 50% or more of the baseline popularity measurements are met; and not recommended if less than 50% of the baseline popularity measurements are met. The baseline popularity measurements may further comprise values for categories of directory information wherein categories of directory information are age, sex, geographic location, and other categorical identifiers. The directory information may be received from potential candidates and voter candidates, and the recommendation generated with take into account a comparison of the categories of directory information from potential candidates and voter candidates with the baseline popularity measurements.

In another alternative embodiment, the method includes a mail service for the potential candidates to send out one or more emails, text messages, and voice messages to one or more addresses requesting votes. In yet another embodiment, the video, photo, text, music, and combinations thereof from potential candidates for the program may be received for a fixed amount of time, and/or the votes from voter candidates are received for a fixed amount of time; for example one day to twelve weeks.

The aforementioned programs are preferably reality television, internet, or other media-based programs, but may also be reality or non-reality programs for television, internet, radio, and combinations thereof. A reality program is a situational show using a majority or all “real” people or non-professional actors. Some programs are competitions and can be focused on one topic, e.g., the next top model, a survival-skills program, a dance competition, or on a type of individual, e.g., college-age students, parents, children, overweight, or athletic individuals.

The baseline popularity measurements may be inputted by a production team, an entity or individual producing the program, or other entity or individual associated with the program and may serve as a baseline for measuring whether or not to produce the program. For example, if the program will include a maximum of 20 contestants, this can be a baseline popularity measurement. The number of potential candidates will need to exceed this. If 1000 potential contestants are preferred for an audition, this can be a baseline popularity measurement and will be included in the aforementioned embodiments. If less than 1000 potential candidates participate in the casting competition, the particular baseline popularity measurement will not be met.

Baseline popularity measurements include, but are not limited to, the preferred number of potential cast members, potential candidates, voter candidates, hits to the web site, advertising revenue, individuals in particular categories of directory information, and may be input by the production team.

The baseline popularity measurements will allow the success of each program to be forecasted and predicted based upon a unique set of values. This is useful for a wide range of programs, including reality television, internet, or other media-based programs, where the number of cast members varies widely, the target audience varies, and the production revenue goals vary.

The system streamlines the casting process allowing a broad search for potential candidates. For example, information from potential candidates may be received from a user interface means such as a graphical user interface to obtain data such as text, video, sound, and still photos of potential candidates. All of the information received can be stored on a database means. The inventive system and method may include a mailing system that allows potential candidates to ask for votes, spread knowledge, and advertise the show.

The inventive system and method may further include processing mechanisms to aggregate, calculate, and compare data. For example, processing may include aggregating the number of potential candidates, voter candidates, visits to the user interface, and revenue generated; calculating the voter rating for potential candidates by subtracting negative votes against from positive votes for the candidates; comparing all of the aforementioned data, and any other data input into the system and involved in the method with a series of baseline popularity measurements that are identified for the particular program.

The inventive system and method may include an announcement of an upcoming program to the general public, an explanation of how the casting process works, and direction of all eligible candidates interested in auditioning to a website that has been created for the show. Databases may be provided that are connected to the program web site wherein candidates can create a candidate profile, including video, text, sound, and still photos. A mailing service may be included via the database that allows the potential candidates to send out an email, text message, or voice message to one or more addresses or phone numbers asking for votes. A set of voter candidates may provide votes for or against the potential candidates, and the votes will be stored in the database for processing, calculating, and comparing. Votes may be received a pre-set period of time. After processing, calculating, and comparing, the candidates with the highest voter rating may be selected as potential cast members, either for further evaluation in a casting audition or as a definite cast member. The subset of potential cast members resulting from the inventive method and system will assist the production team in deciding who will be on the show, greatly reducing the time and money spent in sifting through the countless number of potential candidates that desire to be cast members.

The steps of announcing an upcoming program to the general public and explaining how the casting process works may be via an internet web page, television, radio, text message or other message transmission service.

Eligible potential candidates can be anyone in the general public who desires to appear on the reality program, or may be individuals that pass a pre-screening analysis such as a written or verbal questionnaire. The time period for inputting information and creating a profile may be limited in time, and may involved “closed profiling” where candidate profiles are obscured on the database from view by other candidates or the general public. If closed profiling is used, the production team, the studio, or other entity producing the program determines a pre-set time for opening up access to the candidate profiles on the internet database.

The mailing service via the database may be available to the candidates for a pre-set period of time as well. The mailing service can be populated with web addresses provided by the candidate, or can be to a pre-set list of a plurality of addresses provided by the production team, the studio, or other entity casting the show.

The studio may desire to have “closed voting” wherein voting for candidates is performed by a select group of the production team, the studio, or other entity producing the program, executives, directors, writers, or a select class of individuals characterized by the studio, e.g., individuals that participated in a prior show created by the studio, individuals that attend a certain school, or individuals that pass a pre-screening questionnaire.

The method does not require one or more casting coordinators or one or more casting teams until the final audition, and in some cases, casting coordinators and casting teams are not needed at all. Instead of the production having to go out and look for people to cast, the inventive method of casting brings the people to the production. It eliminates a major expense in producing the show.

### BRIEF DESCRIPTION OF DRAWINGS

FIG. 1 is a depiction of the general architecture of the inventive systems and methods.

FIG. 2 is another depiction of the general architecture of the inventive systems and methods.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for organizing and using the invention in connection with the illustrated embodiments. However, it is to be understood that the same or equivalent functions and sequences may be accomplished by different embodiments that are also intended to be encompassed within the spirit and scope of the invention.

Embodiments of the present invention are described herein in the context of a system, method, and apparatus for producing a program, such as a reality television, internet, or other media-based program that assesses the viability of a program, minimizes financial risk, generates advertising revenue prior to production; generates advertising for the production prior to studio commitment; creates a refined set of potential cast members for a casting call; and creates a built-in fan base of the show, all prior to production. The inventive system, method, and apparatus uses a social network and or a computer network to attract potential candidates and voters. A calculation and processing analysis based upon elements gleaned from a number of input and output factors is utilized to assess the viability and potential success of the reality program to serve as a predictor of whether or not the program will move forward to full production and airing.

In the interest of clarity, not all of the routine features of the implementations described herein are shown and described. It will be appreciated that in the development of any such actual implementation, several implementation-specific decisions must be made in order to achieve a production team's, studio's, or a one producing a program's specific goals, such as compliance with application and business-related constraints, and that these specific goals will vary from one implementation to another and from one entity to another. Development of the network and linking the input calculation means, databases, output, and results values may be a routine undertaking of engineering for those of ordinary skill in the art based upon the disclosure herein.

A program in the inventive embodiments may be a television, radio, Internet, mobile, or cellular based show of any length; and preferably it is a reality program for television.

Internet as used herein may be a collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations that may be made in the future, including changes and additions to existing standard protocols.)

A graphical user interface or interface may be any mechanism by which an external individual or external computer can obtain and provide data, respectively to or from the database of the present invention. One common example of the interface is a web site. Other examples might include an e-mail message, a telephone voice message, or a paper report.

Voter rating is a calculation of number of positive votes for a potential candidate minus the number of negative votes against a potential candidate.

A social network may be an aggregation of individual social relationships that occur via an interface.

A website as used herein may be a computer system that serves informational content over a network using the standard protocols of the World Wide Web. As used herein, the term is generally intended to encompass both (i) the hardware/software server components that serve the informational content over the network, and (ii) the “back end” hardware/software components, including any non-standard or specialized components, that interact with the server components to perform services for web site users.

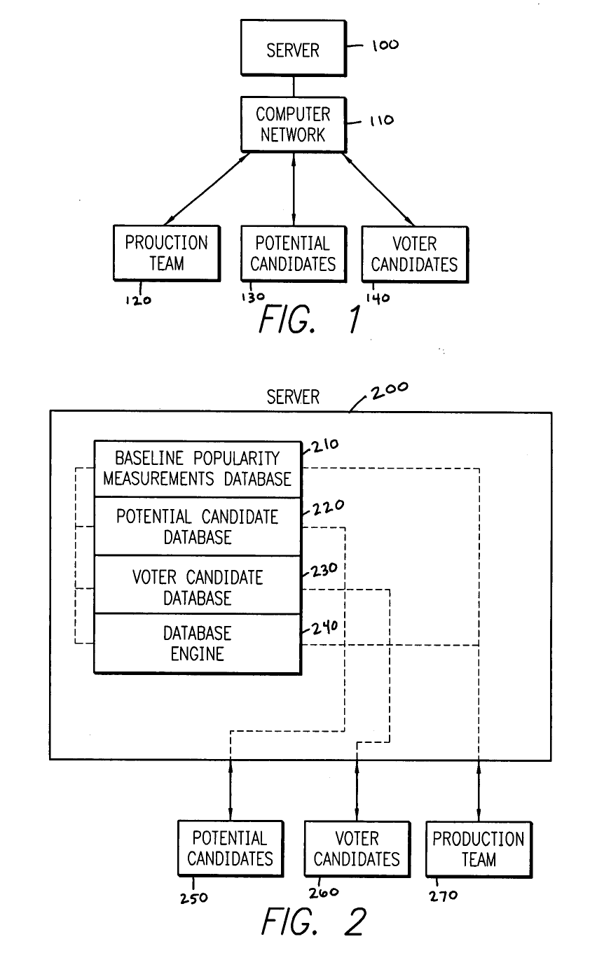

FIG. 1 illustrates the general architecture of a method and system that operates in accordance with several embodiments of the present invention. As shown in FIG. 1, a plurality of interfaces are presented from a plurality of different entities such as the production team 120, one or more potential candidates 130, and one or more voter candidates 140 capable of inputting and receiving information via various different interfaces such as any device capable of presenting data, including, but not limited to, personal computers, cellular telephones, television sets, or hand-held “personal digital assistants,” in connection with a computer network 110 associated with a server 100. As used herein, the term “computer network” generally refers to any public or closed collection of distinct networks working together to appear as a single network to a user, including the Internet or the public world wide web of various connections, connected to each other using the Internet protocol (IP) and other similar protocols. The Internet can provide information about the program, transfer files, receive information, provide information, allow remote log in, and provide electronic mail and mail services. As described herein, the exemplary network of FIG. 1 is for descriptive purposes only. Although the description may refer to terms commonly used in describing particular public networks such as the Internet, the description and concepts equally apply to other public and private computer networks, including systems having architectures similar and dissimilar to that shown in FIG. 1. For example and without limitation thereto, the system of the present invention can find application in public as well as private networks, such as the private network of a production company, talent agency, and or studio. The arrows and connections provided indicate the flow of information to and from the plurality of different entities such as the production team 120, one or more potential candidates 130, and one or more voter candidates 140 in the inventive methods and systems of casting and pre-production of a reality program.

As used herein, production team includes the casting team, the studio, the network, or other entity associated with the program that assists in the pre-production stages of the program.

FIG. 2 illustrates the general architecture of a system according to one or more embodiments of the invention including at least one server 200 hosting a website displaying reality program guidelines and a casting competition in communication over a network with one or more potential candidates 250, one or more voter candidates 260, and the production team 270, and including a database storing baseline popularity measurements 210, a potential candidate database 220, a voter candidate database 230, and a database engine 240.

As will be appreciated by those skilled in the relevant art(s), the configurations of the systems and the methods within the illustrated figures are flexible and can be modified according to the operations implementing the inventive embodiments.

Although the description of the computer server in both figures (100 and 200) may refer to terms commonly used in describing particular computer servers, the description and concepts equally apply to other processing systems, including systems having architectures dissimilar to that shown in the figures.

As used herein, directory information refers to information that describes a potential candidate or voter candidate or characteristics of such candidates; for example, first and last name, age, gender, sex, geographic location, marital status, occupation, and combinations thereof.

The inventive methods may include announcing the upcoming reality television, internet, or other media-based program to the general public by the production team via internet, television, radio, text message, or other message transmission service, explaining how the casting process works, and directing all eligible candidates interested in auditioning to a website that has been created for the television show. Eligible candidates may comprise the general public or a select group of individuals pre-selected by the studio or other entity associated with the program. The website or other interface for uploading candidate profiles may be open for a pre-set window of time in which eligible potential candidates can register, create a candidate profile, and engage in a process of gathering and seeking votes before the online polls open and during the voting. In some cases, the voting “polls” may be open from the start of the casting call when the program announcement is made, and potential candidates can begin receiving votes as soon as their profile has been created. The production team for a particular reality television show or other entity associated with the program may designate a preliminary time window before voting, and the length of that time window if used. Alternatively, potential candidates may be able to input profiles and information and voter candidates may be able to vote and input information at all times.

The potential candidates may input campaign profiles that serve to introduce themselves to the general public, as well as the potential candidates they are competing against during the audition process. Potential candidates will be able to input photos, videos, music, and text in order to attract supporters. In one embodiment of the inventive method and system, all potential candidates that input information will be assigned a campaign number. Additionally, an online mailing list service may be provided to all potential candidates. The potential candidates will be able to send out an email, text, or voice message to all of the web addresses and or telephone numbers they provide, asking for the recipient's vote. Along with a message, the email, text, or voice message will contain a direct link or web address to the candidate's profile on the website, and instructions on how to cast a vote for them. The email, text, or voice message will also show up in the recipient's mailbox as being sent from the sender's personal email, text, or voicemail, as long as the potential candidate provides its email address and telephone number. Potential candidates will also be able to seek votes by word of mouth. In some embodiments, anyone, whether they are competing or not, will be able to look up any potential candidate on the website and cast a vote for them.

In some embodiments of the invention, a specific candidate profile can be looked up on the website by the candidate's name, and/or campaign ID #. Candidates may call friends, family members, or even go door to door telling the people about what they are auditioning for, and asking for their vote. They may give them their campaign number, and/or name to look them up on the website and tell them how the voting process/competition works. They can also ask those people who decide to support them; to campaign for them also by passing on the information to all of the people they know. Supporters may campaign for their candidate via email, phone, or word of mouth.

In some embodiments of the invention, the website announcing the program and the casting competition will be available to the general public. Anyone, including candidates who are auditioning themselves, can view the profiles and/or vote for any of the potential candidates on the web site at any time during the course of the casting process announced by the production team. The general public may cast a vote for any of the potential candidates as voter candidates, whether they personally know that candidate or not. In some embodiments, anyone who is voting can cast a vote for their candidate of choice as often, and as many times as they would like. Alternatively, the number of votes, or votes per day may be limited. In an unlimited setting, a potential candidate's supporter may go on the website all day, every day and cast votes repeatedly.

The voting may be organized in different ways according to different time periods or class of persons eligible to vote depending on the particular reality television show, and will be at the sole discretion of the production team for that program. Alternatively, the voting may be open to a randomly selected class of persons.

In some embodiments of the inventive method and system, the production or other entity associated with the program can choose to have a preliminary time window after the casting call, where any eligible person interested in auditioning can input potential candidate information. A date may be selected for the official launch of the web site, and the opening of the polls which will mark the start of the auditioning process. During the time from when the method or system begins until voter candidates may input information, only potential candidates may input information. The potential candidates will not be able to receive votes at this time, and may not be able to view any other candidates information. The graphical user interface, or other interface where the information is inputted may only have limited features available for a limited time that only allow a potential candidate to input information, thereby creating their candidate profile. In another embodiment, voter candidates may be able to input information or receive information from a mailing service during this time. In such an embodiment, the messages generated by the mailing service may inform the recipient of the official launch date of the candidate information and when the voter candidates will be able to input information and vote for or against potential candidates. Potential candidates may be able to campaign during this time, in all the same ways, simply by informing the people they ask for support of the date they may begin voting for them. When the date comes where voter candidates may input information, all of the features of the graphical user interface or website will be available to anyone who views the site. The ability of potential candidates to input information may be excluded upon a certain date, and all of the candidates who registered to audition prior to this date will now be viewable to the general public. Potential candidates may still be able to request votes and promote the program.

In another embodiment, the production or other entity associated with the program may choose not to have a preliminary time window between the time in which the program is announced, and the time in which potential candidates or voter candidates may input information. In this case, a website or other interface for the program will be launched the day the production or other entity associated with the program requests potential cast members. All of the features of the website or interface may be available from the first day. Eligible potential candidates will not only be able to input information, for example, register and create a candidate profile, but will be able to receive votes as information input from voter candidates as well. Potential candidates may also continue to input information; for example, register and create a candidate profile, throughout the entire course of a pre-set casting period. All of the candidate profiles and information input by the potential candidates may become available to the general public or to a pre-set group of people to view as soon as they are created. Voter candidates may input information; for example, the voting polls will be opened from the date of the announcement of the program or casting call and the competition may continue throughout the course of the casting process.

A date will be set that marks the end of the period where potential candidate and voter information may be inputted, thereby closing the voting polls. The predetermined number of people that the production was looking to cast and input as a baseline popularity measurement for that particular show will be selected by the potential candidates with the highest voter ratings. For example: If the production was looking for 100 people to cast on the television show, 100 candidates will be entered as a baseline popularity measurement, and the 100 potential candidates with the highest voter rating will be selected. The inventive method and system may or may not end there. The production team or other entity associated with the program may decide to cast the television show solely on the outcome of the method of casting based upon the potential candidates with the highest voter rating online voting, or they may also decide to invite the top candidates to an in person audition that will take place in a designated location before the show's producers. Here, the candidates that have received the highest voter rating may audition for the production in person, and will be hand picked by the casting team and/or producers to be cast on the program.

In another embodiment, the production team may want 100 people to compete on a new reality show, such amount will be entered as a baseline popularity measurement, and the 100 candidates with the highest user ratings will be cast on the program. In an alternative embodiment, the production team can say they are looking for 1000 people to audition for a show that 100 people will be cast for, and a target of 1000 potential candidates will be entered as a baseline popularity measurement. The 1000 potential candidates with the highest voter ratings will be invited to a designated time and place to audition in person. 100 people may then be chosen from the 1000 potential candidates with the highest voter ratings and cast on the program. The production can either choose to pay the travel expenses for the 1000 potential candidates invited to the in person audition, or they may tell the people that if they honor the invite it will be at their own expense. In case of the latter, someone who cannot afford or does not want to spend the money to travel to the audition will forfeit their spot, and the potential candidate with the next highest voter ranking will move up a spot allowing a person to take their place. Also, the potential candidates with the highest voter ratings may or may not be revealed to the public before the airing of the show.

All of the aforementioned embodiments may vary depending on the individual production, and will be at the discretion of the program's producers or other entities or individuals associated with the program.

The inventive methods and systems benefit the production of a reality television program all around by significantly reducing the risk involved in moving forward with a show, reducing production costs, and adding convenience for the production team by selecting a subset of the population interested in being a cast member that have a built-in following or audience base by having voter candidates vote for and against the potential cast members. The method enables the production to better estimate the level of success of the show, and has the entity producing the show already making money while it's still in the pre-production stages.

When using the inventive method and system, one of the greatest costs in producing a reality show, that is, hiring a casting coordinator and casting team will be reduced because a casting coordinator/team will not be needed until the final audition, and in some cases, not needed at all. Without the inventive system and method, the casting process is a long, and expensive part of the production process for reality television. Casting calls must be made in all of the cities that the production will be holding auditions in. A casting team must travel to these cities, rent a location to hold the auditions, hire security and other staff to help with the event. The auditions usually run over the course of several days. All of these costs, including the travel expenses of the casting team are paid for by the production. That adds up to be a lot of money! Instead of the production team or other entity involved with the program having to go out and look for people to cast, the inventive method and system brings the people to the production. It cuts out a major expense in producing the show.

Additionally, many potential candidates are not able to make the auditions held in several cities. The inventive system and method enables every eligible person to audition at no inconvenience to them or the production team. With a lot of these popular reality shows, the cities that hold the open auditions usually get flooded with extra congestion during them. It's an inconvenience for the regular commuters, and there is no guarantee that the people who flock to these casting calls will even be seen. A lot of times they wait in line over night, only to be turned down from even auditioning. The inventive system and method guarantees every eligible person who wants to audition, the chance to, and takes away the disruption an open audition causes a city.

This method adds convenience for the production team because it keeps their time and focus at their home base of operation. They do not have to worry about what is going on in different locations. This frees them up to spend more of their time on other aspects of the show, which will also save them money because they will not have to hire extra staff to take on the overflow of responsibilities.

The production or other entity associated with the program will be able to make money while still in the pre-production stage. Since the casting process will take place online, there will be a lot of internet traffic that will attract online advertisers. Selling space to advertise will bring in revenue. Instead of spending money on the casting process, the production will actually be making money on the casting process.

The internet traffic and the amount of potential candidates, among other factors, will help to estimate the level of the show's success. If a large interest is being shown online, the production team can use those facts to charge more for television or internet ads when the show airs. A lack of hits on the web site, or very few potential candidates, among other factors, will give the production team the option of cancelling the project before it spends any real money producing it. This method maximizes profits, and minimizes financial risk.

This method will help with building a viewing audience. The more a reality program involves the viewing audience, the more successful it is. In view of this, the inventive method and system involve the public in the program more than ever before. The public will no longer just be helping to decide who wins the game or competition in the program, but now they will help decide who gets to play it, and if the program even airs. The inventive method and system will allow the public will feel in more control over the outcome of the program than ever before. The public will also be able to get acquainted with the potential candidates throughout inventive method and system, and the casting process by viewing their profiles. Therefore, all of the candidates who get cast will already have a following. Everyone who voted on the website will also be tuning in to see if the candidates they voted for got cast, and if the candidates they voted against did not get cast. Candidates who auditioned but did not get selected will also watch the program to compare themselves to the people cast.

Production teams using the inventive method and system will also save money on promoting the show, because a lot of advertising will not be needed. The candidates that input profiles to be cast on the program, as well as the general public who is taking part in the voting process will be promoting the show. Word of mouth has always been and still is a great form of advertising and it's FREE.

Due to the option of the production team also being able to invite the potential candidates with the highest voter ratings to an in person audition; instead of just casting them on the show, producers will still have creative control over who they would like to see compete. If there is a certain type of person they are looking for they will have the opportunity to pick them out of the finalists who travel to the in person audition. The method will provide the production with all of the benefits, but leave room for the creative professionals to cast the show in the way they see fit.

While the present invention has been described with regards to particular embodiments, it is recognized that additional variations of the present invention may be devised without departing from the inventive concept.

### INDUSTRIAL APPLICABILITY

The inventive methods of pre-production and casting have industrial applicability to all events, programs, shows, concerts, and all different types of media, including television, movies, radio, internet, satellite radio, or other media yet to be created, that require selection of individuals from a large pool of potential candidates, and require a need to minimize risk and avoid wasting time and money in deciding whether or not to move forward with the event, program, show, or concert. The inventive methods can streamline the production process, including the casting process, eliminate the need to take a large risk in creating a program, initiate advertising revenue and hits, and provide a way to assess viability and success of a show. It will further save large amounts of time and money in hiring casting coordinators, casting teams, preparation, planning, and travel.

What is claimed is:

1. A method of casting a reality program comprising:
a. providing at least one server computer in communication with a computer network;
b. generating output from the server to a website to announce a reality program and a casting competition, including guidelines for the competition wherein votes may be for or against a potential candidate;
c. receiving baseline popularity measurements input to the server from a production team, wherein the baseline popularity measurements include a target number of potential cast members;
d. receiving input to the server via the website from potential candidates for the program, wherein the potential candidate input is video, photo, text, music, and combinations thereof;
e. receiving input to the server via the website from voter candidates, wherein the voter candidate input is one or more votes associated with one or more potential candidates; wherein the votes are either positive votes for a candidate or negative votes against a potential candidate;
f. processing a total number of positive votes and a total number of negative votes per potential candidate, and processing a voter rating for each potential candidate by subtracting the total number of negative votes against each potential candidate from the total number of positive votes for each potential candidate; and
g. generating output from the server that identifies the rating for each potential candidate in consecutive order and selects the target number of potential cast members from the potential candidates having the highest voter ratings.

2. The method of claim 1, wherein the target number of potential cast members having the highest voter ratings are invited by the production team to a casting audition.

3. The method of claim 1, wherein the target number of potential cast members having the highest voter ratings are invited by the production team to appear on the program.

4. The method of claim 1, wherein the guidelines for the competition provide that the potential candidates with the highest voter rating may be selected for the cast.

5. The method of claim 1, further comprising generating output from the server as a message service for potential candidates to request votes from voter candidates; receiving input to the server from potential candidates regarding addresses to send one or more messages; and generating output from the server appearing as one or more messages to the addresses identified from the potential candidate.

6. The method of claim 5, wherein the messages are selected from the group consisting of email, text, voice, and combinations thereof.

7. The method of claim 1 wherein the potential candidate text input is one or more categories of potential candidate directory information wherein categories of directory information are age, sex, geographic location, occupation, marital status, and combinations thereof.

8. A system for casting a reality program, in a computer network, the system comprising:
a. at least one server computer hosting a website displaying reality program guidelines and a casting competition, said server having an interface for communicating over a computer network with one or more potential candidates, one or more voter candidates, and a production team;
b. a database storing baseline popularity measurements input by the production team, wherein the baseline popularity measurements include the target number of potential cast members;
c. a potential candidate database associated with the server for receiving information from potential candidates input from the website displaying the program guidelines and the casting competition;
d. a voter candidate database associated with the server for receiving information from voter candidates input from the website;
e. a database engine associated with the server which calculates the number of positive votes for minus the negative votes against each potential candidate to generate a voter rating for each potential candidate;
f. whereby the target number of potential cast members are selected from the potential candidates having the highest voter rating as potential cast members of the reality television program.

9. A method for pre-production of a reality show comprising:
a. providing at least one server computer in communication with a computer network;
b. generating output from the server to a web site announcing a reality show;
c. receiving input to the server of baseline popularity measurements from a production team;
d. receiving input to the server from one or more potential candidates for the program, wherein the potential candidate input is video, photo, text, music, and categories of potential candidate directory information wherein categories of directory information are age, sex, geographic location, occupation, marital status, and combinations thereof;
e. receiving input to the server from one or more voter candidates, wherein the voter candidate input is one or more votes associated with one or more potential candidates, said votes including one or more positive votes for a potential candidate and one or more negative votes against a candidate, and categories of voter candidate directory information;
f. receiving input to the server of advertising revenue generated by the visits to the web site;
g. processing a voter rating per potential candidate, wherein said voter rating equals the number of positive votes minus the number of negative votes;
h. processing the total number of potential candidates, the total number of voter candidates, the total number of visits to the web site, and total amount of advertising revenue;
i. processing the categories of potential candidate directory information and the categories of voter candidate directory information to quantify the number of potential candidates and voter candidates in each category;
j. generating output from the server that identifies the voter rating per potential candidate, the total number of potential candidates, the total number of voter candidates, and the total number of visits to the web site, the total number of potential candidates and voters in each directory information category, a list of potential cast members, and a popularity analysis; wherein the list of potential cast members is generated from the potential candidates with the highest voter ratings and the popularity analysis is based upon a comparison of the baseline popularity measurements with the total number of potential candidates, the total number of voter candidates, the total number of visits to the web site, the total advertising revenue received, and the total number of potential and voter candidates in each category of directory information; and
k. generating output from the server that provides a recommendation for whether or not to produce the show based upon the popularity analysis and identifies the potential cast members.

10. The method of claim 9, wherein the recommendation for whether or not to produce the show is highly recommend, slightly recommend, or do not recommend.

11. The method of claim 10, wherein the recommendation is highly recommend if the results of the popularity analysis show that more than 75% of the baseline popularity measurements are met.

12. The method of claim 10, wherein the recommendation is slightly recommend if the results of the popularity analysis show that 50% to 75% of the baseline popularity measurements are met.

13. The method of claim 10, wherein the recommendation is do not recommend if the results of the popularity analysis show that less than 50% of the baseline popularity measurements are met.

14. The method of claim 9, further comprising generating output from the server requesting one or more addresses and a message, receiving input to the server of one or more addresses from the potential candidates and the message, and generating output from the server of mail containing the message to each of the one or more addresses.

15. A system for predicting, in a computer network, whether or not to produce a reality television program in the pre-production stage of the program, the system comprising:
a. at least one server computer hosting a website displaying program guidelines and a casting competition, said server having an interface for communicating over a computer network with one or more potential candidates, one or more voter candidates, and a production team;
b. a database storing baseline popularity measurements associated with the server for receiving a plurality of baseline popularity measurements from the production team;
c. a potential candidate database associated with the server for receiving information from potential candidates input from the website displaying the program guidelines and the casting competition;
d. a voter candidate database associated with the server for receiving information from voter candidates input from the website displaying the program guidelines and the casting competition, wherein information from voter candidates includes positive votes for and negative votes against one or more potential candidates;
e. a database engine associated with the server which compares the baseline popularity measurements with the total number of potential candidates, the total number of voter candidates, the voter rating per potential candidate wherein the voter rating is calculated based upon the positive votes for minus the negative votes against each potential candidate, and the number of hits to the website;
whereby the program is highly recommended, slightly recommended, or not recommended based upon the analysis of said database engine.

16. The system of claim 15, wherein the program is highly recommended if more than 75% of the baseline popularity measurements are met.

17. The system of claim 15, wherein the preferred number of potential cast members are selected from the potential cast members with the highest voter rating.

18. The system of claim 15, further comprising an advertising revenue database for storing information related to value of advertising revenue received from the website, wherein the baseline popularity measurements further comprise a preferred value of advertising revenue, and the information related to the value of advertising revenue is compared with the baseline popularity measurement for a preferred value of advertising.

19. The system of claim 15, wherein the system predicts the popularity of the reality television program by providing a recommendation rating for actual production of the program.

20. The system of claim 15, wherein the recommendation rating is based upon the number of baseline popularity measurements met.

21. A method that forecasts whether or not to produce a reality television program in the early pre-production stage, the method comprising:
a. providing a web site that includes information on the reality television program and guidelines for participating in a casting competition, and an interface for one or more potential candidates to provide information, one or more voter candidates to vote for potential candidates, and a production team to input baseline popularity measurements;
b. providing baseline popularity measurements from the production team, wherein the baseline popularity measurements quantify the preferred number of potential cast members for the program, the preferred number of voter candidates, the preferred number of hits to the web site, and the preferred amount of advertising revenue generated from the web site;
c. receiving video, photo, text, music, and combinations thereof from potential candidates for the program;
d. receiving votes from voter candidates for one or more potential candidates;
e. receiving advertising revenue generated by visits to the web site;
f. processing the total number of votes per potential candidate, the total number of potential candidates, the total number of voter candidates, the total number of visits to the web site, and total amount of advertising revenue;
g. identifying potential cast members by selecting the preferred number of potential cast members from the potential candidates with the highest number of votes; and
h. providing a recommendation of whether or not to produce the program by comparing the number of votes per potential candidate, the total number of potential candidates, the total number of voter candidates, the total number of visits to the web site, and total amount of advertising revenue with the baseline popularity measurements;
wherein producing the program is highly recommended if more than 75% of the baseline popularity measurements are met, slightly recommended if 50% to 75% of the baseline popularity measurements are met; and not recommended if less than 50% of the baseline popularity measurements are met.

22. The method of claim 21 wherein the baseline popularity measurements further comprise values for categories of directory information wherein categories of directory information are age, sex, geographic location, and other categorical identifiers; wherein the system further comprises receiving categories of directory information from potential candidates and voters; and wherein the recommendation further compares the categories of directory information from potential candidates and voters with the baseline popularity measurements.

23. The method of claim 21 further comprising providing a mail service for the potential candidates to send out one or more emails and text messages to one or more addresses requesting votes.

24. The method of claim 21 wherein the video, photo, text, music, and combinations thereof from potential candidates for the program and the votes from voter candidates for one or more potential candidates are received for a fixed amount of time.
